(19) United States
(12) Patent Application Publication
(10) Pub. No.: US 2009/0108581 A1
(43) Pub. Date: Apr. 30, 2009

(54) FLANGED SLEEVE CONNECTOR FOR SECURE CONDUIT SYSTEM

(75) Inventor: Craig McCarthy, Denton, MD (US)

Correspondence Address: PROCOPIO, CORY, HARGREAVES & SAVITCH LLP, 530 B STREET, SUITE 2100, SAN DIEGO, CA, 92101, US

(73) Assignee: SCRIPPS SECURED DATA, INC. DBA HOLOCOM NETWORKS, Carlsbad, CA (US)

(21) Appl. No.: 12/256,709

(22) Filed: Oct. 23, 2008

Related U.S. Application Data
(60) Provisional application No. 60/982,797, filed on Oct. 26, 2007.

(51) Int. Cl. F16L 23/032

(52) U.S. Cl. 285/405

(57) ABSTRACT

A flanged sleeve connector provides an interface between an end of a secure conduit and a locked enclosure. The connector has a tubular portion of at least partially rectangular or other geometric cross section, and an outwardly projecting flange of circular outer peripheral shape at an end of the first tubular portion. In use, the connector is placed over an opening in a wall of an enclosure or through wall penetration with the flange end face engaging the wall surrounding the opening, and a fastener device inside the enclosure is engaged with fastener formations on the connector to secure the connector to the enclosure. In one embodiment, the connector has a second, externally threaded portion extending from the flange into the enclosure to engage the fastener. In another embodiment, the flanged end of the connector has internal threads.

### RELATED APPLICATION

The present application claims the benefit of U.S. Provisional Application No. 60/982,797 filed on Oct. 26, 2007, which is incorporated herein by reference in its entirety.

### BACKGROUND

1. Field of the Invention

The present invention relates to a flanged sleeve connector for an enclosure in a conduit system, and is particularly concerned with a connector which provides an interface between a locked enclosure, control box, or through wall penetration, and a cable-carrying conduit in a secure network or conduit system.

2. Related Art

In many industries, there is a need for secure routing of signaling and transmission lines such as computer, power, communication and similar cables, wires or tubing such as gas, pneumatic, and hydraulic lines, where access to such lines must be prevented or at least deterred. Secure conduit systems for this purpose are known and generally include one or more locked enclosures or control boxes to permit access and plug in to the system by authorized personnel, together with a secure conduit system which encloses the lines and extends between the control boxes and other similar devices. Such a secure conduit system is described, for example, in U.S. Pat. Nos. 7,049,517, 7,053,303, 7,115,814, and 7,183,488 of McCarthy et al.

The secure conduit system described in the above identified patents has lengths of conduit with ends which connect to locked enclosures, control boxes, or through wall penetrations by means of a flanged sleeve connector. The connector has a first sleeve portion or cylindrical extension which extends through an opening into the locked enclosure, a square flange which rests against an outer surface portion of the enclosure around the opening, and a connector tube portion which projects outwardly from the flange and engages with an end of the secure conduit system. The extension has external threads which engages a nut inside the enclosure which tightly connects the connector to the enclosure. The connector can therefore only be detached from the enclosure by an authorized individual who has access to the interior of the enclosure.

### SUMMARY

Embodiments described herein provide for a flanged sleeve connector which provides an interface between an end of a conduit and an enclosure, control box, a through wall penetration, or other transition piece, and to a control box assembly including the flange connector.

According to one embodiment, a flanged sleeve connector is provided which comprises a sleeve having an outwardly projecting annular flange of circular outer periphery which has a first face which rests against an outer wall of an enclosure, through wall penetration or the like when the connector is secured to the enclosure or through wall penetration, a second face, and a first tubular portion projecting from the second face, and a fastener mechanism having inter-engageable formations which engage corresponding formations on a fastener device inside the enclosure when the connector is secured to the enclosure. The tubular portion may be of rectangular or other cross-sectional shapes.

In one embodiment, the fastener mechanism comprises a second tubular portion which extends from the first face of the flange through an opening in the enclosure wall into the enclosure, and the inter-engageable formations comprise screw threads on the outer surface of the second portion of the sleeve which are engageable with a fastener nut inside the enclosure. In an alternative embodiment, the sleeve has internal screw threads extending inwardly from the first face of the flange which comprise inter-engageable formations which are engageable with a fastener bolt or the like inside the enclosure. The first tubular portion may be straight or may have a bend at any desired angle, depending on the location of the end of the conduit system to which it is to be connected.

The flange connector with an enlarged circular flange covers larger openings in the enclosure wall than the prior art flange connector with a square flange, and has an outer peripheral edge at a uniform spacing from the round hole or opening over which the connector is engaged, unlike a square flange.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a first end perspective view of a flanged sleeve connector for a secure conduit system according to one embodiment;

FIG. 2 is a second end perspective view of the connector of FIG. 1;

FIG. 3 is a perspective view of the connector of FIG. 1 secured to a locked enclosure or access box;

FIG. 4 is a cross sectional view on the lines 4-4 of FIG. 3;

FIG. 5 is a first end perspective view of a second embodiment of the flanged sleeve connector;

FIG. 6 is a second end perspective view of the second embodiment of FIG. 5;

FIG. 7 is a cross sectional view similar to FIG. 3 but illustrating the connector of FIGS. 5 and 6 secured to a wall of a locked enclosure; and

FIG. 8 is a perspective view of a 90 degree connector according to another embodiment.

### DETAILED DESCRIPTION

Certain embodiments as disclosed herein provide for a flanged sleeve connector which provides an interface between an end conduit of a secure conduit system and a control box, secure enclosure, or through wall penetration of the conduit system.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Although the flanged sleeve connector is described below as secured to a wall of an enclosure or control box of a conduit system such as a secure or non-secure conduit system, it may alternatively be secured to any other part of the system such as a through wall penetration that penetrates wall or floor, a transition piece which makes a turn, or any other system function.

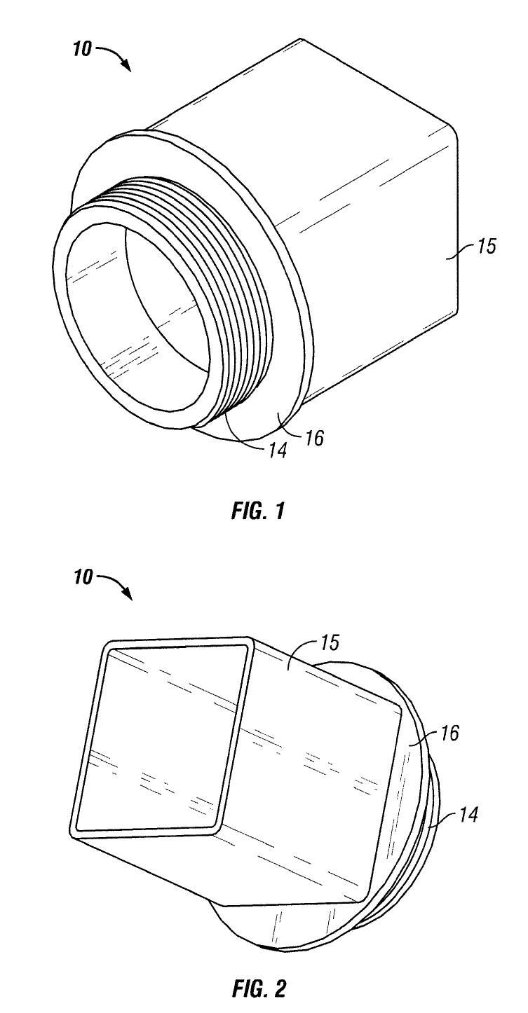

FIGS. 1 to 4 illustrate a first embodiment of a flanged sleeve connector 10 which may be used as an interface between an inlet/outlet end of a secure conduit system, such as the secure conduit system described in U.S. Pat. No. 7,115,814 of McCarthy et al. referenced above, and a secure enclosure or user control box 12 (FIG. 3), or a through wall penetration or other transition piece of the secure conduit system. It should be understood that the control box illustrated in FIG. 3 is by way of example only, and control boxes of many different sizes and configurations may be used in other embodiments, depending on the application. The flange connector 10 is designed such that it can only be released from the box by an authorized user having access to the interior of the box. The secure conduit system includes one or more sections of elongate channel elements securely coupled together to form an elongate conduit with open ends, and each end is connected to a control box by a flange connector 10, with the sections including bends as needed by the installation requirements.

The secure conduit system of which flange connector 10 forms a part may provide a conduit through which electrical, electronic or optical fiber cables, pneumatic tubing, hydraulic tubing or other elongated wiring, cabling or tubing can be routed. The conduit system can be connected at its various ends to secure enclosures 12 which allow for secure controlled access to the cabling inside the conduit system. Typical uses are for computer networks, communication systems, power transmission, equipment control systems, remote sensing systems and the like. Principal uses which may be illustrated as examples in electrical, electronic and telecommunications fields include secure routing of power cables, computer cables and communications cables for networked computer systems and wired telecommunications systems. Locations may be within, between or outside buildings. The secure conduit system may also be used in wireless communications systems, such as for security of landline cabling from the generating or receiving equipment to the sending/receiving antennas. Another example of potential users' systems is a system for remote environmental air, gas or liquid sampling and analysis. In this type of system, a fluid-tight tube, hose or pipe is run from a storage or analysis location to a remote sampling site where the pipe terminates in an open liquid-, air- or gas-sampling device. Periodically or continually samples of the environment at the sampler point are taken, and then transported back through the pipe to a collection system for analysis or directly to an analysis system. Such secured pipe is desired when the liquid, gas or air in the pipe cannot be leaked to the outside or accessed by unauthorized persons or in an unauthorized manner. Such unauthorized access is of particular concern when the liquid, gas or air being sampled is itself flammable, toxic or otherwise dangerous, or when it may be contaminated with or otherwise carry or entrain flammable, toxic or otherwise dangerous components.

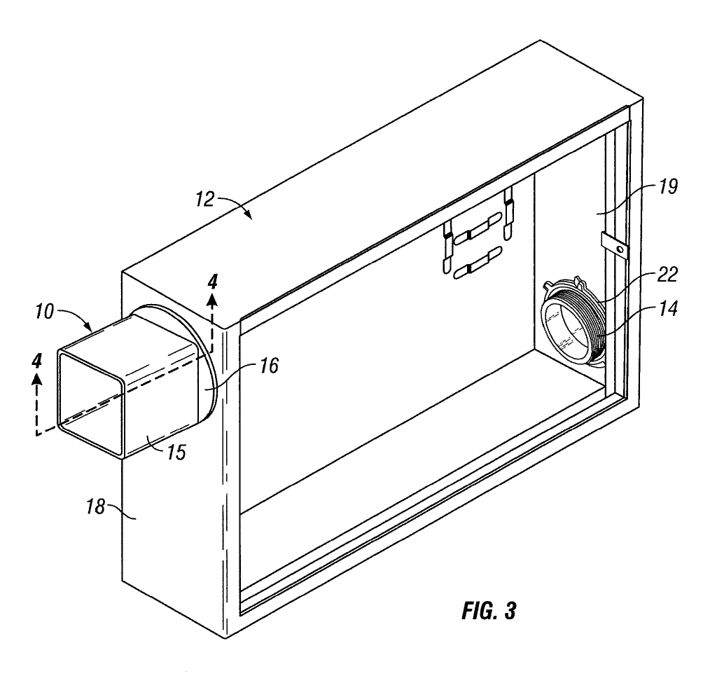

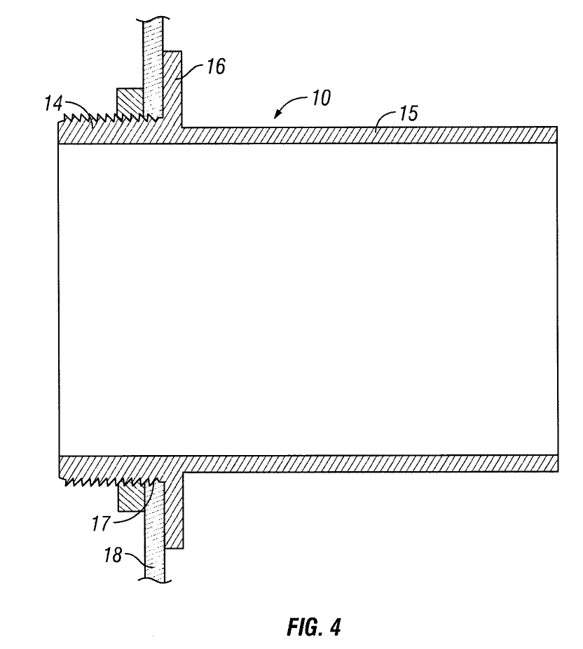

As illustrated in FIGS. 1 and 2, the flanged sleeve connector 10 comprises a hollow sleeve or tubular member having a first, externally threaded cylindrical portion 14, a second portion 15 of generally square or rectangular cross section, and an annular flange 16 of circular shape at the intersection between the cylindrical and square portions 14, 15. The connector 10 may be of metal or other rigid material, such as hard plastic material. FIGS. 3 and 4 illustrate the connector attached through an opening 17 in a wall 18 of a secure enclosure or control box 20, which typically contains one or more connections or sockets to allow a user of the system to plug in an appliance such as a computer terminal to the system. The enclosure 12 is normally closed by a penetration-resistant door (not illustrated) which is locked by a secure lock. An authorized user has a key or combination to the lock and can open the door and access a connection device on the secure system apparatus within the enclosure.

As illustrated in FIG. 4, a suitable nut or fastener 22 is threadably engaged and tightened over the threaded portion 14 of connector 10 which projects into the enclosure through opening 17. This secures the connector to the enclosure, and the connector can then only be removed by release of the nut 22 by an individual who has access to the inside of the locked enclosure. Secondary fasteners such as set screws, rivets, or the like may also be used for securing the connector flange to the enclosure. FIG. 3 illustrates the external portion (flange 16 and square portion 150 of one flange connector 10) secured to one wall 18 of the enclosure so that the flange rests against the outer surface of the wall completely covering opening 18. The inwardly protruding portion 14 of another flange connector 10 is shown in the opposite wall 19, along with the nut or threaded fastener 22 which secures connector to the wall 19.

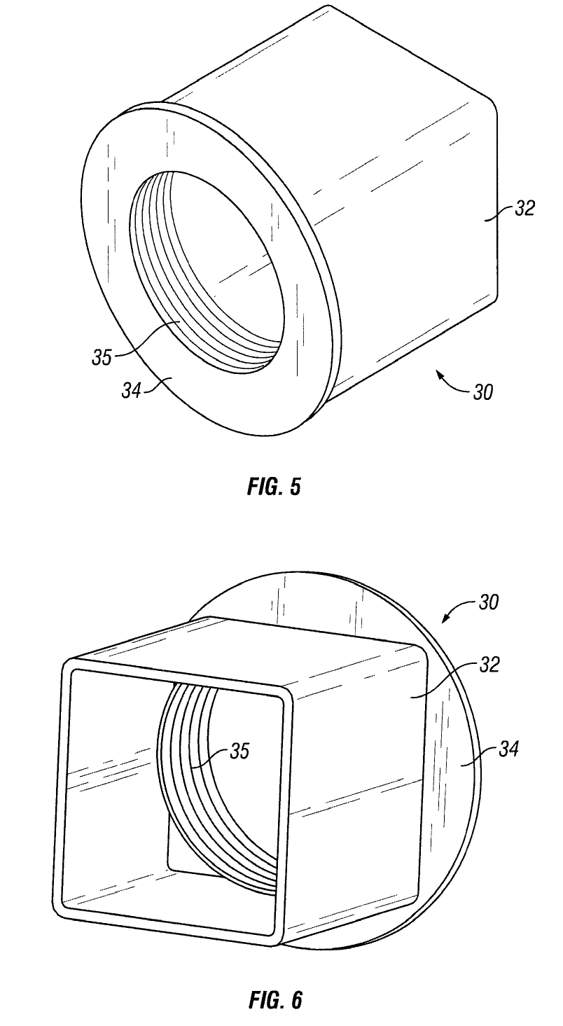

A modified flanged sleeve connector 30 according to a second embodiment is illustrated in FIGS. 5 to 7. Connector 30 is similar to the previous embodiment in that it has a portion 32 of square or rectangular section designed for engagement with the end of a length of a secure conduit system, and a projecting annular or circular flange 34, but in this case the externally threaded portion 14 of the previous embodiment is eliminated, and the connector instead has an internally threaded cylindrical bore portion 35 projecting inward from the outer face of flange 34.

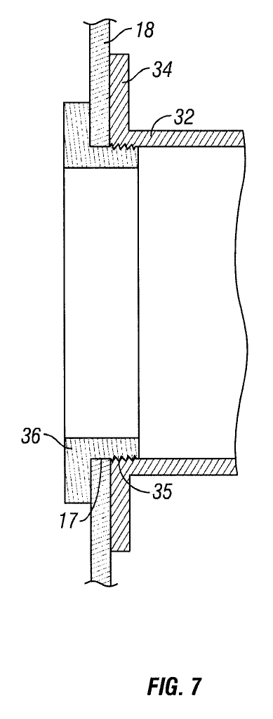

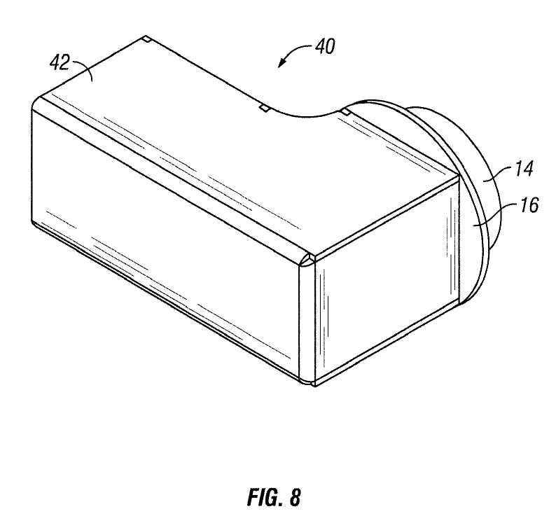

In this embodiment, the connector 30 is placed over an opening 17 in wall 18 of a secure enclosure so that the end face of flange 34 rests flat against the outer surface of the wall 18 around the opening, as illustrated in FIG. 7. A suitable threaded fastener 36 such as a bolt or the like is secured in the threaded bore portion 35 from the inside of the enclosure. The connector 30 then cannot be removed from outside the enclosure, but can only be removed by an authorized individual having access to the interior of the enclosure.

FIG. 8 illustrates a modified flanged sleeve connector 40 in which the straight, rectangular or square cross-section portion 15 of the embodiment of FIGS. 1 to 4 is replaced by a generally square or rectangular tubular portion 42 which has a ninety degree bend. The connector 40 is otherwise identical to connector 10 of FIGS. 1 to 4 and like reference numbers have been used as appropriate. The flange connector 30 of the previous embodiment may also be modified in a similar manner. This allows for connection of secure conduits approaching the enclosure wall from different directions. Other flanged sleeve connectors with round flanges may have end portions with different angled bends to provide for a wide range of different approach directions of the secure conduit system.

The flanged sleeve connector as described above can be used as an interface between a length of conduit in a secure conduit and a secure enclosure of the system, or between a length of conduit and a through wall penetration that penetrates a wall or floor, or transition piece that makes a turn, or performs some other system function. The flanged sleeve connector is connected through an opening in the through wall penetration in exactly the same way as it is connected through an opening in a wall of a secure enclosure as described above and illustrated in the accompanying drawings. Although the foregoing embodiments describe use of the flanged sleeve connector in conjunction with a secure conduit system, in alternative embodiments the connector may be used in a non-secure conduit system as the interface between a non-secure conduit and non-secure enclosure, control box, or the like.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A flanged sleeve connector for connecting a length of conduit to an enclosure, the flanged sleeve connector comprising:
a hollow sleeve member having:
a first, cylindrical portion which engages through an opening in an enclosure for coupling with a fastener inside the enclosure;
a second portion comprising a hollow connector tube having a non-circular cross section coupled to one end of the cylindrical portion, and
an annular, outwardly projecting flange of circular peripheral shape at the intersection between the cylindrical portion and the hollow connector tube, wherein the annular flange seats against an outer surface portion of the enclosure surrounding the opening and the square connector tube projects away from the enclosure when the first cylindrical portion is engaged through the opening.

2. The flanged sleeve connector of claim 1, wherein the cylindrical portion, the hollow connector tube and the annular flange are formed integrally in one piece.

3. The flanged sleeve connector of claim 1, wherein the annular flange has a round central opening.

4. The flanged sleeve connector of claim 3, wherein the diameter of the round opening is greater than the diameter of the cylindrical portion.

5. The flanged sleeve connector of claim 1, wherein the cylindrical portion is externally threaded.

6. The flanged sleeve connector of claim 1, wherein the cylindrical portion is internally threaded.

7. The flanged sleeve connector of claim 1, wherein the hollow sleeve member has a ninety degree bend.

8. The flanged sleeve connector of claim 1, wherein the hollow sleeve member is of rectangular cross-section.

9. A flanged sleeve connector for a conduit system, the flanged sleeve connector comprising:
a hollow sleeve member having a non-circular cross section, the hollow sleeve member having an annular flange of circular shape at one end which engages an external surface portion of an enclosure surrounding an opening in the enclosure; and
an internally threaded cylindrical portion extending from the annular flange into the hollow sleeve member for coupling with a fastener extending through the opening in the enclosure to threadably engage with the internally threaded cylindrical portion.

10. The flanged sleeve connector of claim 9, wherein the hollow sleeve member, the internally threaded cylindrical portion and the annular flange are formed integrally in one piece.

11. The flanged sleeve connector of claim 9, wherein the annular flange has a round central opening.

12. The flanged sleeve connector of claim 11, wherein the cross sectional dimension of the round opening is less than the cross sectional dimension of the bore in the square hollow sleeve member.

13. The flanged sleeve connector of claim 9, wherein the hollow sleeve member has a ninety degree bend.

14. The flanged sleeve connector of claim 9, wherein the hollow sleeve member is of rectangular cross-section.

15. An enclosure assembly for cabling extending through a conduit into the enclosure, comprising:
an enclosure having at least one opening for routing cabling into the enclosure;
a flanged tubular connector having a first end portion for connection to the end of a conduit and a second end portion which extends through the opening into the enclosure, and an outwardly projecting flange at the junction between the first and second end portions which engages an outer surface portion of the enclosure surrounding the opening;
the first end portion being cylindrical and the second end portion being of non-circular cross-section;
the flange having a circular outer peripheral edge; and
a fastener coupled to the first end portion inside the enclosure, whereby the connector is secured to the enclosure.
